(19) United States
(12) Patent Application Publication
(10) Pub. No.: US 2025/0277534 A1
(43) Pub. Date: Sep. 4, 2025

(54) LOW PRESSURE RELIEF VALVE

(71) Applicant: Curtiss-Wright Flow Control Corporation, Brecksville, OH (US)

(72) Inventor: Erwin R.S. CORTEZ, North Royalton, OH (US)

(21) Appl. No.: 19/068,076

(22) Filed: Mar. 3, 2025

Related U.S. Application Data
(60) Provisional application No. 63/560,835, filed on Mar. 4, 2024.

(51) Int. Cl. F16K 17/02

(52) U.S. Cl. CPC F16K 17/02

(57) ABSTRACT

A disc for a pressure relief valve includes a disc body having a core defining a central axis of the disc, and a flange flexibly coupled to the core, the flange defining a seat surface of the disc. The seat surface is axially movable relative to the core.

### CROSS-REFERENCE TO RELATED APPLICATIONS

This application claims the benefit of U.S. provisional application Ser. No. 63/560,835 filed Mar. 4, 2024, the contents of which are incorporated by reference.

### BACKGROUND

Pressure relief valves are used in many industrial applications to prevent fluid systems from reaching undesirable high pressures. Such valves commonly include a nozzle with a valve seat that is normally closed by a slidable disc. The disc is typically biased against the valve seat in the closed configuration by a compression spring, fluid pressure, or both. When a pressure in the nozzle passage exceeds a predetermined set pressure, the disc moves against the biasing force away from the valve seat, thereby opening the valve. Conversely, when pressure in the nozzle passage decreases by a certain amount to a reseat pressure, the biasing force moves the disc back to the closed configuration.

For relief valves with low set pressures (e.g., 50 PSI or less), the biasing force on the disc must be relatively low so the disc can overcome the biasing force and open at the low threshold. However, the disc may not properly engage (and seal) the valve seat in the closed configuration if the biasing force that presses the disc against the valve seat is low. Moreover, increasing the biasing force so the disc properly engages the valve seat can prevent the disc from opening at its low set pressure.

An object of the present disclosure is to provide a disc for a relief valve that can facilitate proper engagement with the valve seat, particularly for low pressure relief valves with low set pressures and low biasing forces acting on the disc.

### BRIEF SUMMARY OF THE INVENTION

The following presents a simplified summary of example embodiments of the invention. This summary is not intended to identify critical elements or to delineate the scope of the invention.

In accordance with a first aspect, a disc for a pressure relief valve includes a disc body having a core defining a central axis of the disc, and a flange flexibly coupled to the core, the flange defining a seat surface of the disc. The seat surface is axially movable relative to the core.

In one example, the flange is resiliently biased toward an unloaded configuration relative to the core, wherein the seat surface extends substantially radial to the central axis in the unloaded configuration.

In another example, the disc body includes polytetrafluoroethylene.

In yet another example, an axial seat stiffness of the flange is about 500 lb/in to about 1500 lb/in.

In still yet another example, the flange includes a distal portion that defines the seat surface, and a proximal portion that flexibly couples the distal portion to the core, wherein a ratio of a smallest axial thickness of the proximal portion to a largest axial thickness of the distal portion is about 0.20 to about 0.32.

In another example, the flange extends radially outward from the core.

In yet another example, an outer diameter of the flange is less than an outer diameter of the core, wherein a difference between the outer diameter of the flange and the outer diameter of the core is at least 0.003 inches.

In still yet another example, the flange includes a beveled surface that extends radially outward from the seat surface, wherein an angle between a direction of the beveled surface and a direction of the seat surface is about 10° to about 20°.

In another example, the flange is resiliently biased toward an unloaded configuration relative to the core, wherein an angle between the beveled surface and a radial direction of the disc in the unloaded configuration is about 10° to about 20°.

In yet another example, the disc body defines an annular groove above the flange, wherein the annular groove is defined at least partially by the flange.

In still yet another example, the disc body defines a recess, wherein the seat surface extends outward from an outer perimeter of the recess.

In another example, an edge between the outer perimeter of the recess and an inner perimeter of the seat surface has a radius of curvature of about 0.020 inches to about 0.040 inches.

In yet another example, a disc assembly includes the disc and a disc holder defining a disc cavity that accommodates the core of the disc.

In still yet another example, the disc holder includes a frustoconical skirt surface extending outward from an outer perimeter of the disc cavity.

In another example, the disc cavity further accommodates the flange of the disc.

In yet another example, an outer diameter of the flange is less than an outer diameter of the core, wherein a difference between the outer diameter of the flange and the outer diameter of the core is at least 0.003 inches.

In still yet another example, the disc holder includes a holder surface that extends outward from an outer perimeter of the disc cavity, wherein an annular gap is defined between the flange of the disc and the holder surface of the disc holder.

In another example, the holder surface extending substantially radial to the central axis.

In yet another example, the disc holder includes a frustoconical skirt surface extending outward from an outer perimeter of the holder surface.

In still yet another example, a pressure relief valve includes the disc assembly and a nozzle defining a bore, an opening at an end of the bore, and a seat surface that surrounds a perimeter to the opening. The disc assembly is translatable between an open configuration in which the seat surface of the disc is spaced from the seat surface of the nozzle, and a closed configuration in which the seat surface of the disc engages the seat surface of the nozzle.

### BRIEF DESCRIPTION OF THE DRAWINGS

The above and other features, aspects, and advantages of the present application are better understood when the following detailed description of the present application is read with reference to the accompanying drawings, in which:

FIG. 1 is a cross-sectional view of an example first embodiment of a relief valve;

FIG. 2 is an enlarged view of the first embodiment;

FIG. 3 is a cross-sectional view of a disc of the first embodiment, showing various dimensions of the disc;

FIG. 4 is a cross-sectional view of an example second embodiment of a relief valve; and

FIG. 5 is an enlarged view of the second embodiment.

### DETAILED DESCRIPTION

The following is a detailed description of illustrative embodiments of the present application. As these embodiments of the present application are described with reference to the aforementioned drawings, various modifications or adaptations of the methods and or specific structures described may become apparent to those skilled in the art. All such modifications, adaptations, or variations that rely upon the teachings of the present application, and through which these teachings have advanced the art, are considered to be within the spirit and scope of the present application. Hence, these descriptions and drawings are not to be considered in a limiting sense as it is understood that the present application is in no way limited to the embodiments illustrated.

Moreover, certain terminology is used herein for convenience only and is not to be taken as a limitation. For example, relative directional terms herein such as “upper”, “lower”, and the like are used for convenience when describing the embodiments as oriented in the drawings. However, such orientation(s) are arbitrary, and different orientations can result rearranging which feature might be considered the “upper” or “lower,” etc.

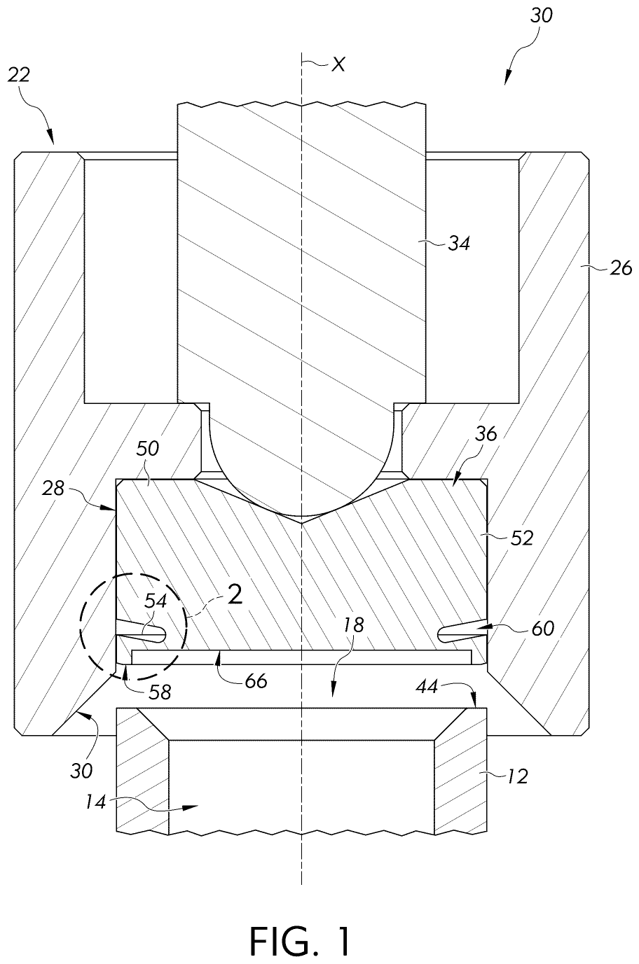

Turning to FIG. 1, a first embodiment of an example pressure relief valve 10 is shown for relieving pressure in a fluid system. The relief valve 10 includes a nozzle 12, which is a generally tubular body defining a bore 14 with an opening 18 at its upper end. The relief valve 10 further includes a disc assembly 22 that is movable relative to the nozzle 12 to selectively open and close the opening 18 of the nozzle 12.

The disc assembly 22 includes a disc holder 26 that defines a cylindrical disc cavity 28 and a frustoconical skirt surface 30 extending radially outward and downward from a lower perimeter of the disc cavity 28. The disc assembly 22 also includes an elongated shaft 34 that extends into the disc cavity 28, and a disc 36 that is arranged within the disc cavity 28 and coupled to the lower end of the shaft 34. The disc 36 thereby secures the disc holder 26 to the shaft 34. In the present example, the disc 36 is fixed to the shaft 34. In other examples, the disc 36 can be movably (e.g., pivotally) coupled to the lower end of the shaft 34, allowing the disc 36 and disc holder 26 to be slightly movable relative to the shaft 34 to account for potential misalignments between the disc assembly 22 and nozzle 12 during operation.

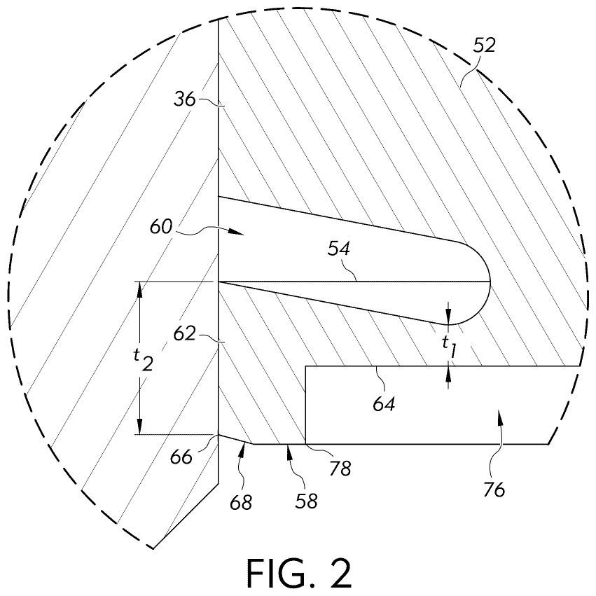

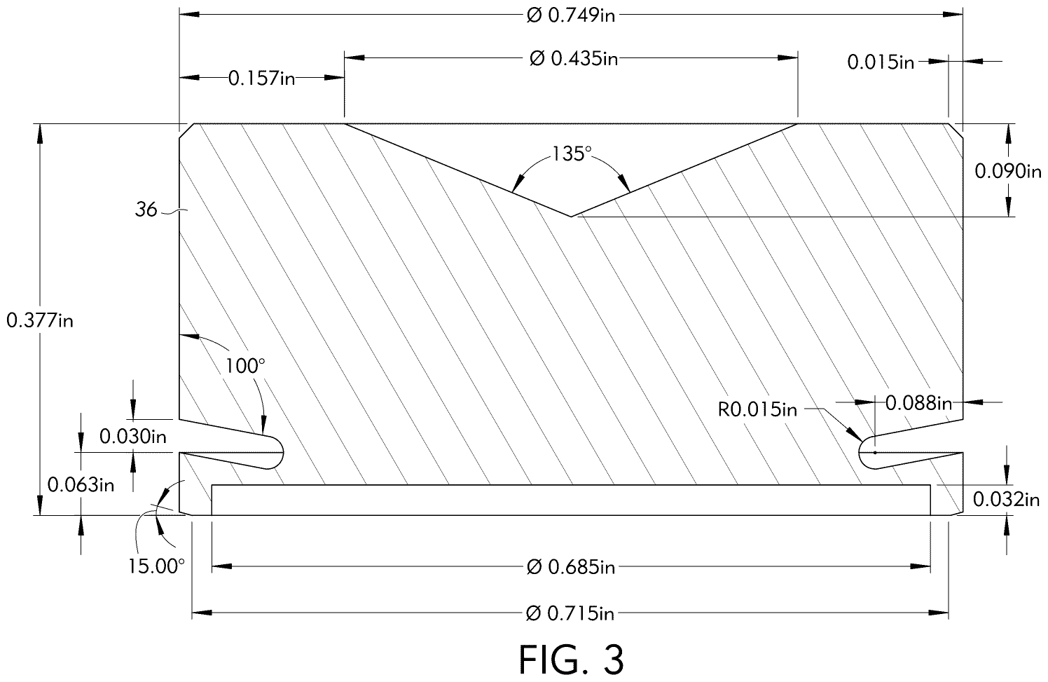

FIG. 2 shows an enlarged view of the relief valve 10, while FIG. 3 shows a detailed view of various dimensions for the valve's disc 36. The nozzle 12, disc holder 26, shaft 34, and disc 36 are all arranged to be coaxial with a central axis X of the relief valve 10 (see FIG. 1). In other words, the central axis X shown in FIG. 1 corresponds to the central axes of the nozzle 12, shaft 34, disc holder 26, and disc 36. Moreover, the nozzle 12, shaft 34, disc holder 26, and disc 36 all extend symmetrically about the central axis X, such that their cross-sections shown in FIG. 1 extend circumferentially and continuously about the central axis X. Notably, the central axis X defines axial and radial directions of the relieve valve 10 and its features described herein. The central axis X also defines inward and outward directions of the relief valve 10 and its features, such that outward features are further away from the central axis X in the radial direction as compared to inward features.

The nozzle 12 has an annular seat surface 44 that extends radially outward from the perimeter of its opening 18. The disc assembly 22 is translatable along the central axis X between an open configuration (shown in FIG. 1) in which the disc 36 is axially spaced from the seat surface 44, and a closed configuration in which the disc 36 engages the seat surface 44. Moreover, the disc assembly 22 is biased toward the closed configuration via one or more biasing elements. For example, the relief valve 10 can include a compressed spring (not shown) that applies axial force against the disc assembly 22 in a direction toward the seat surface 44. In addition or alternatively, the disc assembly 22 may be biased toward the seat surface 44 via gravity, magnetic force, and/or some other feature that applies biasing force to disc assembly 22.

When the disc assembly 22 is in the closed configuration and fluid pressure within the nozzle 12 exceeds a predetermined set pressure, the pressurized fluid will act against disc 36 of the disc assembly 22 and overcome its biasing force, causing the disc assembly 22 to translate axially (against the biasing force) away from the seat surface 44 to the open configuration shown in FIG. 1. This will permit the pressurized fluid within the nozzle 12 to escape via the opening 18. The pressurized fluid will continue to act against the disc 36 and frustoconical skirt surface 30 of the disc holder 26 as it leaves nozzle 12, thereby maintaining the disc assembly 22 in the open configuration. However, if the fluid pressure drops below a predetermined reseat pressure, the biasing force against the disc assembly 22 will overcome the fluid force of the lower-pressure fluid, causing the disc assembly 22 to translate axially toward the seat surface 44 to the closed configuration.

Preferably, the disc 36 of the disc assembly 22 will engage the seat surface 44 of the nozzle 12 in the closed configuration to form a continuous seal around the opening 18 of the nozzle 12, thereby inhibiting fluid within the nozzle 12 from escaping between the disc 36 and seat surface 44. In conventional relief valves, this can typically be achieved by applying sufficient biasing force against the disc assembly, such that the disc presses and conforms against the seat surface to yield a continuous seal. However, as discussed above, the biasing force for relief valves with low set pressures (e.g., 50 PSI or less) must be relatively low so the disc can overcome the biasing force and open at the low threshold. Thus, the disc 36 of the present embodiment is configured to facilitate proper engagement with the seat surface 44, particularly in low-pressure applications with relatively low biasing forces acting on the disc assembly 22.

More specifically, the disc 36 comprises a single, monolithic body 50 of material. Preferably, the disc body 50 comprises Teflon (i.e., polytetrafluoroethylene), although other materials are possible including, for example, silicone, neoprene, polychlorotrifluoroethylene, etc. The disc body 50 comprises a core 52 that is coaxial with the central axis X. The disc body 50 also includes an annular flange 54 that is flexibly coupled to the core 52 and defines an annular seat surface 58 for engagement with the seat surface 44 of the nozzle 12 in the closed configuration. The core 52 and flange 54 of the disc body 50 define an annular groove 60 just above the flange 54 that is coaxial with the central axis X and extends inward from an outer perimeter of the disc body 50.

The flange 54 is a flexible body that is cantilevered from the core 52. In particular the flange 54 includes a distal portion 62 (see FIG. 2) that defines the seat surface 58, and a proximal portion 64 that flexibly couples the distal portion 62 to the core 52 such that the distal portion 62 can move (e.g., pivot) axially upward or downward relative to the core 52. Moreover, the flange 54 is preferably resiliently biased to the “unloaded configuration” shown in FIGS. 1-3, such that the flange 54 assumes the unloaded configuration when no external load (besides gravity) is acting on and bending the flange 54 relative to the core 52. It is to be appreciated that the configurations of the flange 54 described below relate to the flange 54 in its unloaded configuration, unless clearly described otherwise.

As discussed further below, the flexible and resilient configuration of the flange 54 enables the seat surface 58 to flex and move (e.g., pivot) relative to the core 52, in order to facilitate proper engagement of the seat surface 58 with the nozzle 12 in the closed configuration.

The flexible and resilient configuration of the flange 54 is enabled by the elastic material used for the disc body 50, as well as the configuration (e.g., shape, thickness) of the flange 54 as it extends outward from the core 52.

More specifically, as shown in FIG. 2, the proximal portion 64 of the flange 54 is tapered such that its axial thickness (measured in the axial direction) gradually increases in the radially outward direction. Meanwhile, the distal portion 62 is substantially larger in axial thickness than the proximal portion 64. Preferably, a ratio of the smallest axial thickness t₁ of the proximal portion 64 to the largest axial thickness t₂ of the distal portion 62 is about 0.20 to about 0.32 and more preferably, about 0.24 to about 0.28. In the present embodiment, the smallest axial thickness t₁ of the proximal portion 64 is about 0.016 inches and the largest axial thickness t₂ of the distal portion 62 is about 0.060 inches, such that the ratio of t₁/t₂ is about 0.27.

The relatively small thickness of the proximal portion 64 enables the flange 54 to bend so the seat surface 58 can move (e.g., pivot) relative to the core 52. In particular, the distal portion 62 can pivot relative to the core 52 such that the seat surface 58 moves axially upward or downward from the position shown in FIGS. 1-3. Moreover, the relatively larger thickness of the distal portion 62 ensures that the annular shape of the seat surface 58 still has sufficient rigidity for proper alignment with the nozzle 12. The larger thickness of the distal portion 62 also can increase its weight to help bias the seat surface 58 downward into engagement with the nozzle 12.

The core 52, on the other hand, is significantly larger than the flange 54 in mass and axial thickness. The core 52 is therefore much stiffer than the flange 54, and can serve as a rigid anchor for the proximal end of the flange 54. In particular, the core 52 can fit snugly within the disc cavity 28 of the disc holder 26, and can be coupled to the distal end of the shaft 34, thereby securing the disc 36 and disc holder 26 thereto. The distal portion 62 of the flange 54 can thus move relative to the core 52 and the other elements 28, 30 of the disc assembly 22.

The disc 36 as described above thus includes a resiliently flexible flange 54 with a seat surface 58 that can pivot and move in the axial direction relative to the core 52, thereby enabling the seat surface 58 to better conform to the seat surface 44 of the nozzle 12 in the closed configuration, even in low-pressure applications with relatively low biasing forces acting on the disc assembly 22.

Preferably, the seat surface 58 will have an axial seat stiffness k relative to the core 52 that is about 500 lb/in to about 1500 lb/in. For the purposes of this disclosure, an “axial seat stiffness” of a seat surface relative to another feature (e.g., a core) corresponds to the ratio of force per unit deformation of the seat surface relative to the other feature in the axial direction. For example, the axial seat stiffness k of the seat surface 58 in the present embodiment can be calculated using the formula below, wherein d₀ is an axial distance between the seat surface 58 and the bottom of the core 52 in the unloaded configuration when no external load is applied to the seat surface 58, and dₓ is an axial distance between the seat surface 58 and the bottom of the core 52 when the distal portion 62 of the disc 36 is forced into engagement with the seat surface 44 in the closed configuration and deflects relative to the core 52. In the formula below, Pₓ represents the set pressure of the valve 10 (e.g., 50 PSI) that causes the disc assembly 22 to move upward from the closed configuration, while A represents an exposed surface area of the disc 36 that is exposed to fluid within the bore 14 in the closed configuration. In other words, the product of Pₓ and A can be equivalent to and represent the force that is ultimately applied to the seat surface 44 in the closed configuration and causes the seat surface 58 to deflect to the distance dₓ.

$$k = \frac{{P}_{x} * A}{{d}_{0} - {d}_{x}}$$

Notably, the annular groove 60 just above the flange 54 enables the proximal portion 64 to pivot upward without engaging the rest of the disc body 50. In the present example, the groove 60 is angled such that an outer end of the groove 60 is axially higher than an inner end of the groove 60. In other examples, the groove 60 may be angled such that its outer end is axially lower than its inner end. Moreover, in some examples, the groove 60 may extend generally perpendicular to the central axis X.

As the flange 54 engages the seat surface 44 and pivots upward relative to the core 52, a lower outer edge 66 of the flange 54 can flare radially outward, such that the outer diameter of the flange 54 increases. However, this expansion of the flange's outer diameter could lead to interference between the disc holder 26 and the flange 54, particularly if the disc cavity 28 has an inner diameter that approximates the outer dimeter of the core 52. Accordingly, in order to prevent such interference, the outer diameter of the flange 54 (in the unloaded configuration) is preferably less than an outer diameter of the core 52. In particular, a difference between the outer diameter of the flange 54 and the outer diameter of the core 52 can be at least about 0.003 inches.

Moreover, the flange 54 can include a beveled surface 68 that extends radially outward and upward from an outer perimeter of its annular seat surface 58 to the lower outer edge 66, wherein the beveled surface 68 extends in a direction oblique to the annular seat surface 58. In particular, an angle between the beveled surface 68 and a direction of the annular seat surface 58 (which is substantially parallel to the radial direction in the unloaded configuration) is preferably about 10° to about 20°, and more preferably about 15°. This angle of the beveled surface 68 can help further prevent interference between the disc holder 26 and the flange 54 as the lower outer edge 66 flares outward.

Finally, the disc 36 in the present example defines a lower recess 76 at its bottom end, which can receive fluid from the nozzle 12 and help concentrate fluid force against the disc assembly 22. The seat surface 58 extends radially outward from an outer perimeter of the lower recess 76. Moreover, in the present embodiment, a sharp edge 78 is provided between the outer perimeter of the recess 76 and the inner perimeter of the seat surface 58. However, to help strengthen the edge 78, the edge 78 can be rounded such that it has a radius of curvature of about 0.020 inches to about 0.040 inches, preferably about 0.030 inches.

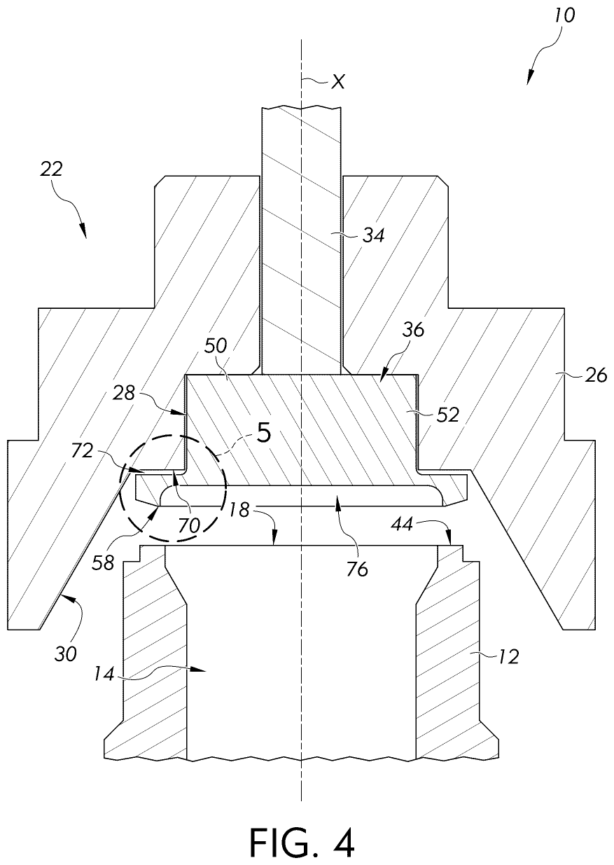

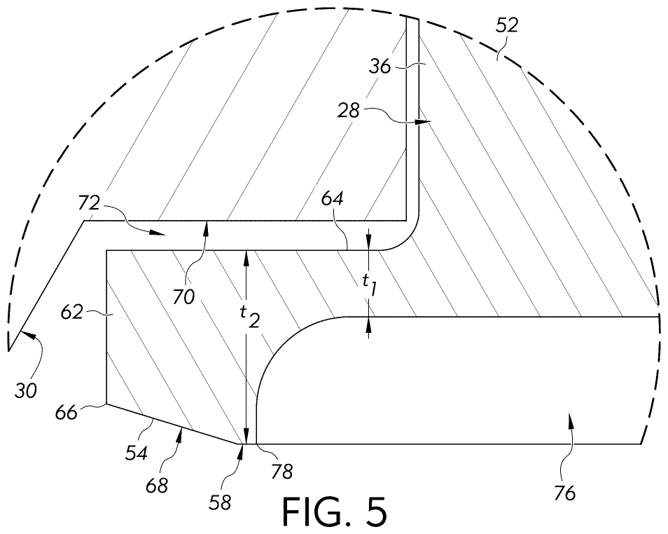

It is to be appreciated that the shape, size, and material of the disc 36 all influence its flexibility and resiliency, and can vary by embodiment without departing from the scope of the disclosure. For instance, FIGS. 4 and 5 show a second embodiment of the relief valve 10 and its disc 36, wherein the disc 36 is similarly inserted within the disc cavity 28 of the disc holder 26. Elements in the second embodiment that are similar to those of the first embodiment in FIGS. 1-3 are denoted by the same reference numerals. Except for differences readily apparent from the drawings and description below, it is to be appreciated that the above descriptions of elements for the embodiment in FIGS. 1-3 similarly apply to the elements with the same reference numerals in the second embodiment, and therefore such descriptions have been omitted for the second embodiment.

In the second embodiment, the disc 36 does not include any groove above its flange 54. Rather, the core 52 is a substantially cylindrical body and the flange 54 extends radially from a lower end of the core 52. Moreover, the disc holder 26 in the second embodiment has an annular surface 70 that extends radially between the lower perimeter of the disc cavity 28 and the inner perimeter of the frustoconical skirt surface 30. The disc 36 is similarly inserted within the disc cavity 28 of the disc holder 26, but the flange 54 of the disc 36 is arranged outside of the disc cavity 28 and spaced below the annular surface 70. Accordingly, a gap 72 is provided between the flange 54 and annular surface 70, which enables the flange 54 to flex upwards without engaging the disc holder 26.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A disc for a pressure relief valve, the disc comprising a disc body that includes:
a core defining a central axis of the disc, and
a flange flexibly coupled to the core, the flange defining a seat surface of the disc,
wherein the seat surface is axially movable relative to the core.

2. The disc according to claim 1, wherein the flange is resiliently biased toward an unloaded configuration relative to the core, wherein the seat surface extends substantially radial to the central axis in the unloaded configuration.

3. The disc according to claim 1, wherein the disc body comprises polytetrafluoroethylene.

4. The disc according to claim 1, wherein an axial seat stiffness of the flange is about 500 lb/in to about 1500 lb/in.

5. The disc according to claim 1, wherein the flange includes:
a distal portion that defines the seat surface, and
a proximal portion that flexibly couples the distal portion to the core,
wherein a ratio of a smallest axial thickness of the proximal portion to a largest axial thickness of the distal portion is about 0.20 to about 0.32.

6. The disc according to claim 1, wherein the flange extends radially outward from the core.

7. The disc according to claim 1, wherein an outer diameter of the flange is less than an outer diameter of the core, wherein a difference between the outer diameter of the flange and the outer diameter of the core is at least 0.003 inches.

8. The disc according to claim 1, wherein the flange includes a beveled surface that extends radially outward from the seat surface, wherein an angle between a direction of the beveled surface and a direction of the seat surface is about 10° to about 20°.

9. The disc according to claim 8, wherein the flange is resiliently biased toward an unloaded configuration relative to the core, wherein an angle between the beveled surface and a radial direction of the disc in the unloaded configuration is about 10° to about 20°.

10. The disc according to claim 1, wherein the disc body defines an annular groove above the flange, wherein the annular groove is defined at least partially by the flange.

11. The disc according to claim 1, wherein the disc body defines a recess, wherein the seat surface extends outward from an outer perimeter of the recess.

12. The disc according to claim 11, wherein an edge between the outer perimeter of the recess and an inner perimeter of the seat surface has a radius of curvature of about 0.020 inches to about 0.040 inches.

13. A disc assembly comprising:
the disc according to claim 1, and
a disc holder defining a disc cavity that accommodates the core of the disc.

14. The disc assembly according to claim 13, wherein the disc holder includes a frustoconical skirt surface extending outward from an outer perimeter of the disc cavity.

15. The disc assembly according to claim 13, wherein the disc cavity further accommodates the flange of the disc.

16. The disc assembly according to claim 15, wherein an outer diameter of the flange is less than an outer diameter of the core, wherein a difference between the outer diameter of the flange and the outer diameter of the core is at least 0.003 inches.

17. The disc assembly according to claim 13, wherein the disc holder includes a holder surface that extends outward from an outer perimeter of the disc cavity,
wherein an annular gap is defined between the flange of the disc and the holder surface of the disc holder.

18. The disc assembly according to claim 13, the holder surface extending substantially radial to the central axis.

19. The disc assembly according to claim 13, wherein the disc holder includes a frustoconical skirt surface extending outward from an outer perimeter of the holder surface.

20. A pressure relief valve comprising:
the disc assembly according to claim 13, and
a nozzle defining a bore, an opening at an end of the bore, and a seat surface that surrounds a perimeter to the opening,
wherein the disc assembly is translatable between an open configuration in which the seat surface of the disc is spaced from the seat surface of the nozzle, and a closed configuration in which the seat surface of the disc engages the seat surface of the nozzle.
